(19) United States
(12) Patent Application Publication
(10) Pub. No.: US 2026/0310152 A1
(43) Pub. Date: Oct. 8, 2026

(54) INFORMATION PROCESSING APPARATUS, INFORMATION PROCESSING METHOD, INFORMATION PROCESSING PROGRAM, AND DISTRIBUTED CONTROL SYSTEM

(71) Applicant: Yokogawa Electric Corporation, Tokyo (JP)

(72) Inventors: Yoshitaka YOSHIDA, Tokyo (JP); Hideki MURATA, Tokyo (JP); Takeshi TOINAGA, Tokyo (JP)

(21) Appl. No.: 19/164,513

(22) PCT Filed: Feb. 27, 2024
(86) PCT No.: PCT/JP2024/007092

§ 371 Date: Sep. 11, 2025

(30) Foreign Application Priority Data
Mar. 17, 2023 (JP) 2023-043524

(51) Int. Cl. G05B 19/042

(52) U.S. Cl. CPC G05B 19/042; G05B 2219/25232

(57) ABSTRACT

An information processing apparatus includes: a processor configured to: calculate, based on information that indicates a situation of data access to each of a plurality of control nodes, a load placed on each of the plurality of control nodes; and give a notification when one of the loads placed on the plurality of control nodes exceeds a threshold.

### TECHNICAL FIELD

The present invention relates to an information processing apparatus, an information processing method, an information processing program, and a distributed control system.

### BACKGROUND ART

Conventionally, there is a known distributed control system (DCS) in which a plurality of control nodes that are connected by a network each other perform control of a plant (for example, see NPL 1).

### CITATION LIST

### Patent Literature

NPL 1: Japanese National Publication of International Patent Application No. 2017-511024

### SUMMARY OF INVENTION

### Technical Problem

However, in the conventional DCS, there is a problem in that it is not possible to inhibit a state in which a control node becomes an overload.

In the case where OPC-UA is used for communication among the control nodes, an inquiry is made to a global discovery server (GDS). For example, the inquiry that is made to the GDS is performed by aiming at authentication among the control nodes and finding out a control node that holds data that is desired to be accessed by a human machine interface (HMI) server.

The inquiry to the GDS is made just one time; however, due to the characteristics of process control, data access is steadily performed with respect to each of the control nodes, and thus, the same load is continuously placed on each of the control nodes. The data access mentioned here is acquisition of monitoring data performed by the HMI server, acquisition of a process node performed by a control node, communication between the control nodes, or the like.

Accordingly, it is an object in one aspect of an embodiment of the present invention to inhibit each of the control nodes included in the DCS from becoming an overload.

### Solution to Problem

An information processing apparatus includes: a calculation unit that calculates, based on information that indicates a situation of data access to each of a plurality of control nodes, a load placed on each of the plurality of control nodes; and a notification unit that gives a notification when one of the loads placed on the plurality of control nodes exceeds a threshold.

An information processing method causes a computer to execute a process comprising: calculating, based on information that indicates a situation of data access to each of a plurality of control nodes, a load placed on each of the plurality of control nodes; and giving a notification when one of the loads placed on the plurality of control nodes exceeds a threshold.

An information processing program causes a computer to execute a process comprising: calculating, based on information that indicates a situation of data access to each of a plurality of control nodes, a load placed on each of the plurality of control nodes; and giving a notification when one of the loads placed on the plurality of control nodes exceeds a threshold.

A distributed control system includes: a management server that notifies about a data access destination in accordance with an inquiry; a plurality of control nodes; and a monitoring server, wherein each of the plurality of control nodes makes an inquiry to the management server, and performs data access with each other in accordance with the notification received from the management server, the monitoring server makes an inquiry to the management server, and performs data access to one of the plurality of control nodes in accordance with the notification received from the management server, and the management server includes a calculation unit that calculates, based on information that indicates a situation of data access to each of a plurality of control nodes, a load placed on each of the plurality of control nodes; and a notification unit that gives a notification when one of the loads placed on the plurality of control nodes exceeds a threshold.

### Advantageous Effects of Invention

According to an embodiment, it is possible to inhibit each of the control nodes included in the DCS from becoming an overload.

### BRIEF DESCRIPTION OF DRAWINGS

FIG. 1 is a diagram illustrating an example of a configuration of a distributed control system according to a first embodiment.

FIG. 2 is a diagram illustrating an example of a configuration of a management server according to the first embodiment.

FIG. 3 is a diagram illustrating an example of task information.

FIG. 4 is a diagram illustrating an example of data access.

FIG. 5 is a diagram illustrating an example of data access.

FIG. 6 is a flowchart illustrating the flow of a process performed by a management server.

FIG. 7 is a diagram explaining an example of a hardware configuration.

### DESCRIPTION OF EMBODIMENTS

Preferred embodiments of an information processing apparatus, an information processing method, an information processing program, and a distributed control system disclosed in the present invention will be described in detail below with reference to the accompanying drawings. Furthermore, the present invention is not limited to the embodiments. In addition, the same components are denoted by the same reference numerals and an overlapping description will be omitted. Each of the embodiments can be used in any appropriate combination as long as they do not conflict with each other. Furthermore, a management server is one example of the information processing apparatus.

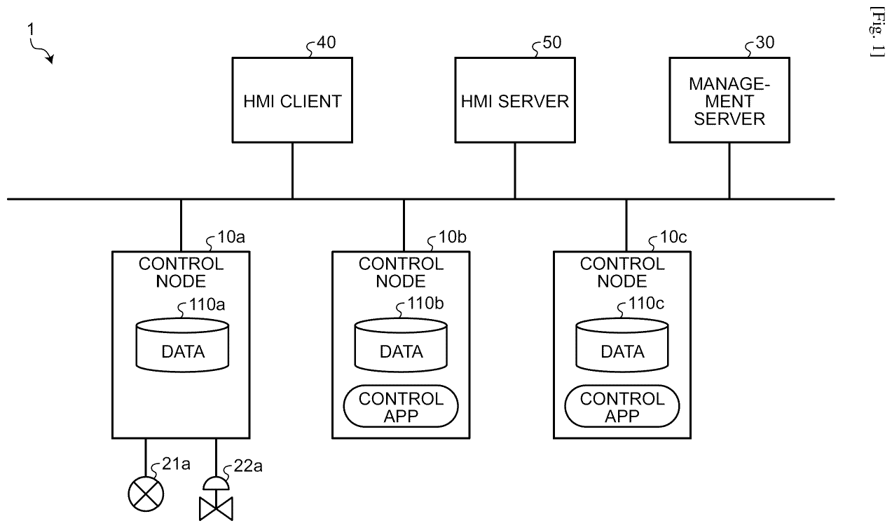

A configuration of a distributed control system according to a first embodiment will be described with reference to FIG. 1. FIG. 1 is a diagram illustrating an example of the configuration of the distributed control system according to the first embodiment.

As illustrated in FIG. 1, a distributed control system 1 includes a control node 10a, a control node 10b, a control node 10c, a field instrument 21a, a field instrument 22a, a management server 30, a HMI client 40, and a HMI server 50.

In a description below, each of the control nodes are sometimes collectively referred to as a control node 10. Furthermore, in a description below, each of the field instruments is sometimes collectively referred to as a field instrument 20.

The number of control nodes 10 and field instrument 20 included in the distributed control system 1 is not limited to the number illustrated in FIG. 1. Furthermore, one or more of the field instruments 20 may be connected to each of the control nodes 10, and the field instrument 20 need not always be connected to each of the control nodes 10.

The field instrument 20 is provided in a plant. The plant is, for example, a petroleum plant, a petrochemical plant, a chemical plant, or a gas plant. By operating the plant, product materials, such as liquefied natural gas (LNG), a resin (plastic, nylon, etc.), and a chemical substance product, are able to be obtained.

Furthermore, the plant includes, for example, a factory facility, a machine facility, a production facility, an electric-generating facility, a storage facility, and a facility in a wellhead for mining petroleum, natural gas, or the like. In addition, in the plant, a facility device that is used to generate the product material is provided.

The field instrument 20 acquires information related to the state of the plant. For example, examples of the field instrument 20 include an instrument, such as a temperature sensor, a pH sensor, a velocity sensor, an acceleration sensor, an atmospheric pressure sensor, and a gas concentration sensor, an instrument that detects a degree of opening of a valve, an instrument that detects a state (on or off) of a switch, and the like.

The field instrument 20 transmits, to the control node 10, data indicating a sensor value or a detection result on the basis of a communication protocol that is determined in advance.

The control node 10 performs an allocated task. The task corresponds to a part or all of arithmetic operations generated in accordance with execution of an application. For example, the task is a function that is included in an application, a function block (FB), a function module, or the like. Moreover, the task may be the one that uses data that is received from the field instrument 20.

Moreover, the control application (control APP) illustrated in FIG. 1 is an application for performing a task.

Furthermore, the control node 10a, the control node 10b, and the control node 10c stores therein data 110a, data 110b, and data 110c, respectively. The data 110a, the data 110b, and the data 110c may be data obtained from the field instrument 20, or may be data obtained by performing the task.

The management server 30 is connected to the control node 10 via a network. The management server 30 functions as GDS (reference URL: https://jp.opcfoundation.org/wp-content/uploads/sites/2/2018/12/4_Endo_OPCUA_GD S.pdf). The GDS manages a list of OPC-UA applications and a certification that is used for the applications.

Furthermore, the management server 30 functions as an Alias. The Alias corresponds to a name solution function of a domain name system (DNS) in an IP network, and manages an association relationship between a node name or a tag name and an IP address.

The HMI client 40 is connected to the HMI server 50. Furthermore, the HMI server 50 acquires information for monitoring the field instrument 20, and provides the acquired information to the HMI client 40.

Here, the distributed control system 1 is one example of a process control system. In the process control system, real-time processing and non-real-time processing are performed. Furthermore, the task performed by the control node 10 includes the real-time processing and the non-real-time processing.

The real-time processing is execution of the control application, data transmission and reception performed between the control nodes. For example, the real-time processing is a process (for example, PID control) for controlling the field instrument 20 performed on the basis of the information that is acquired by the control node 10 from the field instrument 20.

The non-real-time processing is a process related to system monitoring, field instrument management, quality management, advanced control, or the like. For example, the non-real-time processing is a process that is performed by using pieces of data that are collected from the plurality of control nodes 10 over a certain period of time. Moreover, in this case, each of the plurality of control nodes 10 outputs the data acquired from the field instrument 20 after converting the form of the data in accordance with the process that is performed at a latter step.

Furthermore, in the non-real-time processing, a process that requires a certain level of arithmetic operation performance and a process that requires a special device, such as a graphics processing unit (GPU), are included.

In the conventional DCS, the real-time processing was conventionally performed by a controller (for example, corresponding to the control node 10). Furthermore, in the conventional DCS, the non-real-time processing was conventionally performed by a device that is different from the controller, such as a PC or a server.

In contrast, recently, an open process control system, such as an open process automation (OPA) system (reference literature: https://www.yokogawa.com/us/solutions/featured-topics/open-process-automation/), that is advocated by an open process automation forum (OPAF) is proposed. In the OPA system, hierarchies of the processes are flattened, and the real-time processing is also required in the device that is different from the controller, such as a server. In contrast, there may also be a case in which non-real-time processing is performed in the control node.

The control node used in the OPA system is sometimes referred to as a distributed control node (DCN). Furthermore, the control node according to the present embodiment is, for example, a distributed control node (DCN) included in the OPA system.

The control node 10 receives steady data access while performing the tasks that have been described above. As a result of this, the control node 10 may sometimes become an overload. However, with the management function according to the present embodiment, it is possible to inhibit the control node 10 from becoming an overload.

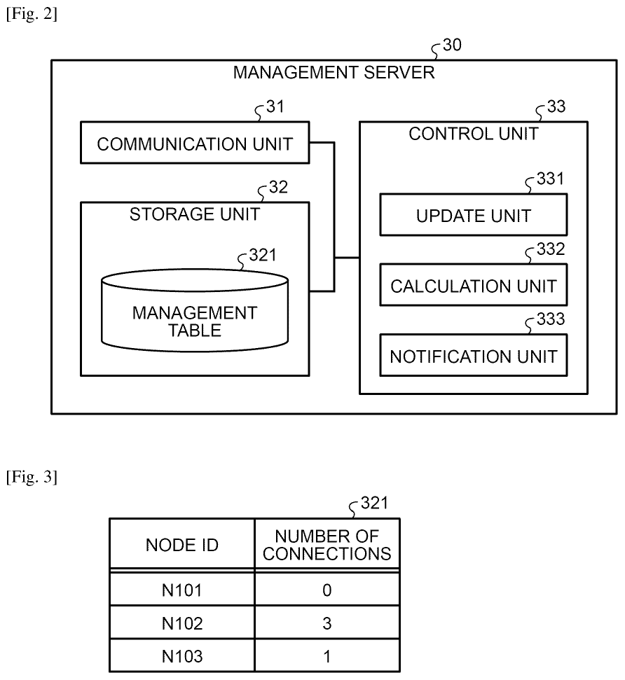

A configuration of the management server 30 will be described with reference to FIG. 2. FIG. 2 is a diagram illustrating an example of a configuration of the management server according to the first embodiment. As illustrated in FIG. 2, the management server 30 includes a communication unit 31, a storage unit 32, and a control unit 33.

The communication unit 31 performs communication about data with the other devices. For example, the communication unit 31 is a communication interface. The communication unit 31 communicates with the control node 10 and the HMI server 50.

The storage unit 32 stores therein various kinds of data, various kinds of programs that are executed by the control unit 33, and the like. For example, the storage unit 32 is a storage device, such as a memory and a hard disk. The storage unit 32 stores therein various kinds of data that are generated from the process performed by the management server 30, including the data obtained in the course of the various kinds of processes performed by the control unit 33, the processing results that are obtained from the various kinds of processes that are performed, and the like.

The storage unit 32 stores therein a management table 321.

The management table 321 is a table that manages the number of connections of each of the control nodes 10. The number of connections corresponds to the number of devices that performs data access to the control nodes 10.

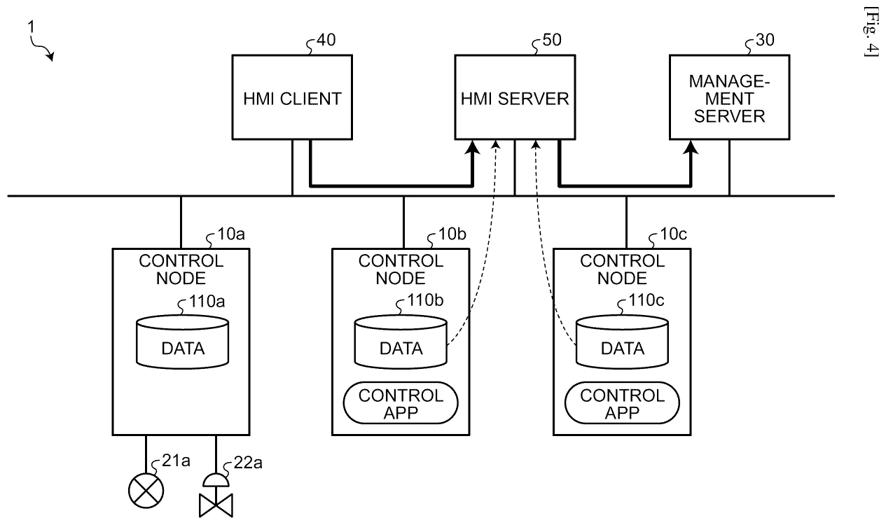

Here, the node IDs of the control node 10a, the control node 10b, and the control node 10c are denoted by “N101”, “N102”, and “N103”, respectively. For example, FIG. 3 illustrates a case in which the number of connections to the control node 10a having the node ID of “N101” is zero.

The control unit 33 is a processing unit that manages the entire of the management server 30. The control unit 33 is implemented by, for example, a processor, or the like. The control unit 33 includes an update unit 331, a calculation unit 332, and a notification unit 333.

The update unit 331 updates the management table 321 when the number of connections to the control node 10 has been changed. In the following, a case in which the update unit 331 updates the management table 321 will be described.

### Case 1: System Monitoring

The update unit 331 updates the management table 321 in order to perform system monitoring when the HMI server 50 starts acquisition of data from the control node 10.

For example, as illustrated in FIG. 4, the HMI server 50 makes an inquiry (access inquiry) to the management server 30 in order to acquire the data 110b and the data 110c. FIG. 4 is a diagram illustrating an example of data access.

Each of the plurality of control nodes 10 makes an inquiry to the management server 30 and performs data access with each other in accordance with a notification sent from the management server 30. Furthermore, the HMI server 50 makes an inquiry to the management server 30, and performs data access to one of the plurality of control nodes 10 in accordance with a notification received from the management server 30. Moreover, the HMI server 50 is one example of a monitoring server.

The management server 30 performs the function as the GDS, and notifies the HMI server 50 that the data 110b is present in the control node 10b (the node ID of “N102”) and the data 110c is present in the control node 10c (the node ID of “N103”).

After the HMI server 50 has received the notification, the HMI server 50 periodically acquires the data 110b from the control node 10b and periodically acquires the data 110c from the control node 10c.

In this case, the update unit 331 increments the number of connections to each of the control node 10b (the node ID of “N102”) and the control node 10c (the node ID of “N103”) indicated in the management table 321 by one.

### Case 2: Communication Between Control Nodes Performed For Control Arithmetic Operation

The update unit 331 updates the management table 321 when communication between the control nodes is started to perform a control arithmetic operation.

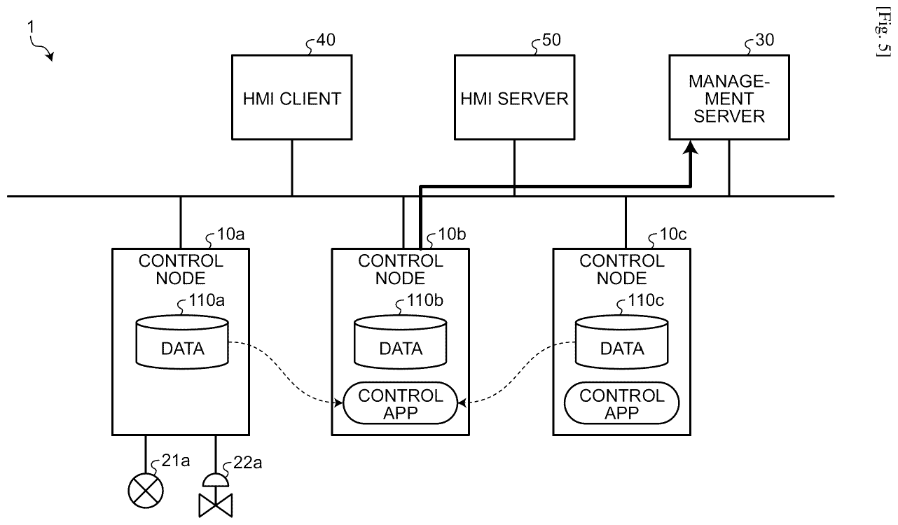

For example, as illustrated in FIG. 5, the control node 10b makes an inquiry (an access inquiry) to the management server 30 in order to acquire the data 110a and the data 110c. FIG. 5 is a diagram illustrating an example of data access.

The management server 30 performs the function as the GDS, and notifies the control node 10b that the data 110a is present in the control node 10a (the node ID of “N101”) and the data 110c is present in the control node 10c (the node ID of “N103”).

After the control node 10b has received the notification, the control node 10b periodically acquires the data 110a from the control node 10a and periodically acquires the data 110c from the control node 10c.

In this case, the update unit 331 increments the number of connections to each of the control node 10a (the node ID of “N101”) and the control node 10c (the node ID of “N103”) indicated in the management table 321 by one.

The management server 30 updates the management table 321 related to the control node 10 that has been targeted for the access inquiry, and starts a packet capture. As a result of this, the management server 30 is able to obtain the size of the data that is acquired from the control node 10 by the data access and is able to obtain a period for which the data is acquired.

When the data access to the control node 10 has been canceled, the management server 30 decreases the number of connections to the subject control node 10 stored in the management table 321, and ends the packet capture.

The calculation unit 332 calculates each of the loads of the plurality of control nodes 10 on the basis of the information (for example, the management table 321) that indicates a situation of the data access performed with respect to each of the plurality of control nodes 10.

The calculation unit 332 is able to calculate the load on the basis of the number of pieces of data access performed with respect to each of the plurality of control nodes 10. For example, the calculation unit 332 calculates a load with a higher value as the number of connections recorded in the management table 321 is increased.

Moreover, an algorithm for calculating a load performed by the calculation unit 332 is described by a language, such as Jscript, python (registered trademark), or the C language, and is implemented by a program that is embedded in advance.

Furthermore, the calculation unit 332 may calculate a load in consideration of the size of the data that is to be acquired at the time of data access and the period for which the data is acquired. In this case, the management table 321 stores therein the data size to be acquired and the acquisition period of the data for each access source (for example, the control node 10 or the HMI server 50) of the data access.

Furthermore, the calculation unit 332 may correct the calculated load on the basis of each of the loads that are placed on the plurality of respective control nodes 10 and that are indicated by the already known management function (Redfish, etc.).

For example, the calculation unit 332 calculates an average value a of differences between the loads that are indicated by the management function and the loads that are calculated by the calculation unit 332. Then, the calculation unit 332 calculates a value obtained by adding a to the load calculated by the calculation unit 332 as a correction value of the load. Moreover, a may be a positive value or may be a negative value.

In this way, the calculation unit 332 is able to correct the calculated load on the basis of the difference between the calculated load and the load that is indicated by the management function.

Furthermore, for example, the calculation unit 332 calculates a ratio (proportion) β of the load that is indicated by the management function to the load that is calculated by the calculation unit 332. Then, the calculation unit 332 calculates a value obtained by multiplying β by the load that has been calculated by the calculation unit 332 as the correction value of the load. Moreover, β may be a value that is equal to or greater than one or may be a value that is less than one.

In this way, the calculation unit 332 is able to correct the calculated load on the basis of the ratio of the calculated load to the load indicated by the management function.

The calculation unit 332 may calculate a and β for each control node, or may calculate α and β related to all of the control nodes.

The notification unit 333 gives a notification when one of the loads placed on the plurality of control nodes 10 exceeds a threshold. Moreover, a different threshold may be set to each of the plurality of control nodes 10 in accordance with the individual performance.

For example, when the load (or the correction value) calculated by the calculation unit 332 exceeds the threshold, the notification unit 333 outputs an alert to an operator via the HMI server 50 or the HMI client 40.

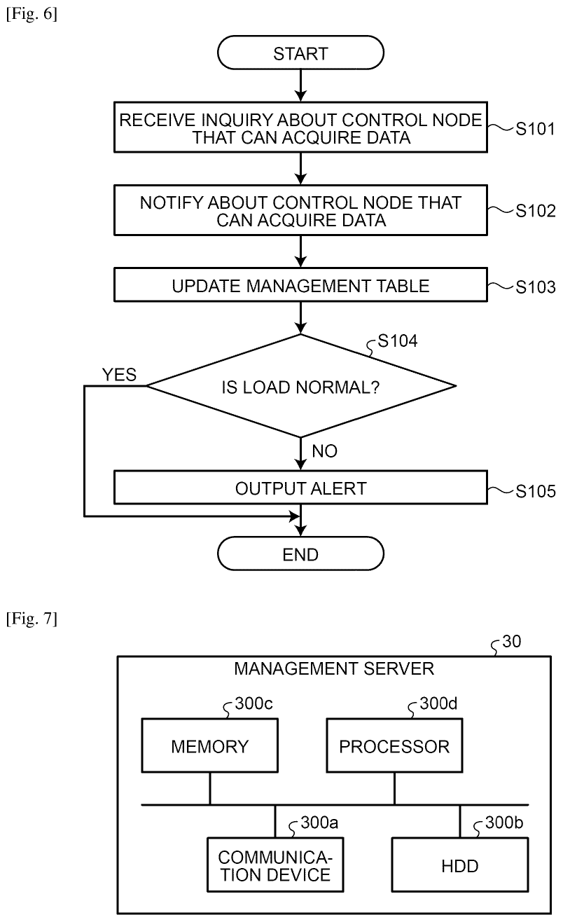

The flow of the process performed by the management server 30 will be described with reference to FIG. 6. FIG. 6 is a flowchart illustrating the flow of the process performed by the management server.

As illustrated in FIG. 6, first, the management server 30 receives an inquiry about the control node that is able to acquire the data (Step S101). The inquiry is made by the control node 10 or the HMI server 50.

The management server 30 gives a notification of the control node that is able to acquire the data in accordance with the inquiry (Step S102). After this, data access is started with respect to the control node that is able to acquire the data.

For example, the management server 30 converts the data name that has been specified by the inquiry to an IP address by using the name solution function. For example, if the data 110b has been specified, the management server 30 notifies the inquiry source of the IP address of the control node 10b.

The management server 30 updates the management table 321 related to the control node to which the notification that data is able to be acquired has been sent (Step S103). For example, the management server 30 increases the number of connections to the control nodes indicated in the management table 321.

Then, the management server 30 calculates the load placed on each of the control nodes on the basis of the management table 321, and determines whether or not each of the loads is in a normal state (Step S104). For example, the management server 30 determines whether or not each of the calculated loads exceeds the threshold.

If one of the loads placed on the control nodes is not in a normal state (for example, if one of the loads exceeds the threshold) (No at Step S104), the management server 30 outputs an alert (Step S105).

If one of the loads placed on the control nodes is in a normal state (for example, if one of the loads does not exceed the threshold) (Yes at Step S104), the management server 30 ends the process without outputting an alert.

The operator is able to manually perform adjustment according to the load situation in accordance with the notification received from the management server 30.

Furthermore, the management server 30 may automatically perform load balancing on the control node 10. For example, if the load placed on the control node 10 exceeds the threshold, the management server 30 allocates the task of the subject control node 10 to the other control node 10, the server, or the like.

Furthermore, in the case where actual measurement can be performed on the load placed on the control node 10, the obtained actual measurement of the load may be fed back to the management server 30. In this case, the management server 30 is able to optimize the algorithm for calculating the load in response to the feedback. For example, the management server 30 holds the constant similar to α and β described above independently of the management function, and corrects the constant in accordance with the feedback.

### Effects

As described above, the management server 30 includes the calculation unit 332 and the notification unit 333. The calculation unit 332 calculates, on the information that indicates the situation of the data access to each of the plurality of control nodes 10, the load placed on each of the plurality of control nodes 10. The notification unit 333 gives a notification in the case where one of the loads placed on the plurality of control nodes 10 exceeds the threshold.

For example, the calculation unit 332 calculates each of the loads on the basis of the number of pieces of data access to the plurality of control nodes 10.

The operator is able to adopt a measure to reduce the load in accordance with the notification. In this way, with the management server 30, it is possible to inhibit the control node included in the distributed control system 1 (DCS) from becoming an overload.

Furthermore, if the load placed on the control node 10 falls below a permissible amount (for example, about 90% of the permissible amount), the control node 10 is able to accurately report the own load to the outside. In contrast, if the load placed on the control node 10 exceeds the permissible amount (for example, about 120% of the permissible amount), the control node 10 may possibly have difficulty in accurately reporting the own load to the outside. Even in such a case, the management server 30 is able to calculate the load placed on the control node 10.

The management server 30 is able to calculate the load without acquiring any information from the control node 10 by itself. As a result of this, the management server 30 is able to calculate the load irrespective of the difference in the vendors and the specifications of the control node 10.

Furthermore, the calculation unit 332 corrects the calculated load on the basis of each of the loads placed on the plurality of respective control nodes 10 indicated by the management function. For example, the calculation unit 332 corrects each of the calculated loads on the basis of the difference between each of the calculated loads and each of the loads that are indicated by the management function. For example, the calculation unit 332 corrects the calculated load on the basis of the ratio of each of the load that are indicated by the management function to the respective calculated load. If one of the corrected loads exceeds the threshold, the notification unit 333 gives a notification. As a result of this, the management server 30 is able to improve the calculation accuracy of the load.

### System

The flow of the processes, the control procedures, the specific names, and the information containing various kinds of data or parameters indicated in the above specification and drawings can be arbitrarily changed unless otherwise stated.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, all or any part of each of the processing functions performed by the each of the devices can be implemented by a CPU and by programs analyzed and executed by the CPU or implemented as hardware by wired logic.

### Hardware

In the following, an example of a hardware configuration of the management server 30 will be described. FIG. 7 is a diagram illustrating an example of the hardware configuration. As illustrated in FIG. 7, the management server 30 includes a communication device 300a, a hard disk drive (HDD) 300b, a memory 300c, and a processor 300d. Furthermore, each of the units illustrated in FIG. 7 is connected by a bus or the like with each other.

The communication device 300a is a network interface card or the like, and communicates with another server. The HDD 300b stores therein the programs and the DBs that operate the functions illustrated in FIG. 2.

The processor 300d operates the process that executes each of the functions described above in FIG. 2 or the like by reading the programs that execute the same process as that performed by each of the processing units illustrated in FIG. 2 from the HDD 300b or the like and loading the read programs in the memory 300c. For example, the process executes the same functions as those performed by each of the processing units included in the management server 30. Specifically, the processor 300d reads, from the HDD 300b or the I like, the program having the same function as that performed by the update unit 331, the calculation unit 332, and the notification unit 333. Then, the processor 300d executes the process for executing the same process as that performed by the update unit 331, the calculation unit 332, and the notification unit 333.

In this way, the management server 30 is operated as an information processing apparatus that performs an information processing method by reading and executing the program. Furthermore, the management server 30 is also able to implement the same functions as those described above in the embodiment by reading the above described program from a recording medium by a medium reading device and executing the read program. In addition, the program described in another embodiment are not limited to be executed by the management server 30. For example, the present invention may also be similarly used in a case in which another computer or a server executes a program or in a case in which another computer and a server cooperatively execute the program with each other.

The programs may be distributed via a network, such as the Internet. Furthermore, the program may be executed by storing the programs in a recording medium that can be read by a computer readable medium, such as a hard disk, a flexible disk (FD), a CD-ROM, a magneto-optical disk (MO), a digital versatile disk (DVD), or the like, and read the programs from the recording medium by the computer.

Some examples of combinations of the disclosed technical features are described in the following.
(1)

An information processing apparatus comprising:
a calculation unit that calculates, based on information that indicates a situation of data access to each of a plurality of control nodes, a load placed on each of the plurality of control nodes; and
a notification unit that gives a notification when one of the loads placed on the plurality of control nodes exceeds a threshold.
(2)

The information processing apparatus according to (1), wherein the calculation unit calculates each of the loads based on the number of pieces of data access to each of the plurality of control nodes.
(3)

The information processing apparatus according to (1) or (2), wherein
the calculation unit corrects each of the calculated loads based on each of the loads that are placed on the plurality of respective control nodes and that are indicated by a management function, and
the notification unit gives the notification when one of the corrected loads exceeds the threshold.
(4)

The information processing apparatus according to any one of (1) to (3), wherein
the calculation unit corrects each of the calculated loads based on a difference between each of the calculated loads and each of the loads that are indicated by the management function, and
the notification unit gives the notification when one of the corrected loads exceeds the threshold.
(5)

The information processing apparatus according to any one of (1) to (3), wherein the calculation unit corrects each of the calculated loads based on a ratio of each of the loads indicated by the management function to the respective calculated loads, and the notification unit gives the notification when one of the corrected loads exceeds the threshold.
(6)

A distributed control system comprising:
a management server that notifies about a data access destination in accordance with an inquiry;
a plurality of control nodes; and
a monitoring server, wherein
each of the plurality of control nodes makes an inquiry to the management server, and performs data access with each other in accordance with the notification received from the management server,
the monitoring server execute a process same as a process the information processing apparatus according to any one of (1) to (5) executes.

### REFERENCE SIGNS LIST

1 distributed control system
10, 10a, 10b, 10c control node
20, 21a, 22a field instrument
30 management server
31 communication unit
32 storage unit
33 control unit
40 HMI client
50 HMI server
110a, 110b, 110c data
321 management table
331 update unit
332 calculation unit
333 notification unit

1. An information processing apparatus comprising:
a processor configured to:
calculate, based on information that indicates a situation of data access to each of a plurality of control nodes, a load placed on each of the plurality of control nodes; and
give a notification when one of the loads placed on the plurality of control nodes exceeds a threshold.

2. The information processing apparatus according to claim 1, wherein
the processor is configured to
calculate each of the loads based on the number of pieces of data access to each of the plurality of control nodes.

3. The information processing apparatus according to claim 1, wherein
the processor is configured to
correct each of the calculated loads based on each of the loads that are placed on the plurality of respective control nodes and that are indicated by a management function, and
give the notification when one of the corrected loads exceeds the threshold.

4. The information processing apparatus according to claim 3, wherein
the processor is configured to
correct each of the calculated loads based on a difference between each of the calculated loads and each of the loads that are indicated by the management function, and
give the notification when one of the corrected loads exceeds the threshold.

5. The information processing apparatus according to claim 3, wherein
the processor is configured to
correct each of the calculated loads based on a ratio of each of the loads indicated by the management function to the respective calculated loads, and
give the notification when one of the corrected loads exceeds the threshold.

6. An information processing method that causes a computer to execute a process comprising:
calculating, based on information that indicates a situation of data access to each of a plurality of control nodes, a load placed on each of the plurality of control nodes; and
giving a notification when one of the loads placed on the plurality of control nodes exceeds a threshold.

7. A non-transitory computer-readable recording medium having stored therein a program that causes a computer to execute a process comprising:
calculating, based on information that indicates a situation of data access to each of a plurality of control nodes, a load placed on each of the plurality of control nodes; and
giving a notification when one of the loads placed on the plurality of control nodes exceeds a threshold.

8. (canceled)
